(19) United States
(12) Patent Application Publication
(10) Pub. No.: US 2009/0205844 A1
(43) Pub. Date: Aug. 20, 2009

(54) HOOF PLANE

(75) Inventor: Norbert Althoff, Lindlar (DE)

Correspondence Address: BROWDY AND NEIMARK, P.L.L.C.;624 NINTH STREET, NW, SUITE 300, WASHINGTON, DC, 20001-5303, US

(73) Assignee: August Ruggeberg GmbH & Co. KG, Marienheide (DE)

(21) Appl. No.: 12/372,389

(22) Filed: Feb. 17, 2009

(30) Foreign Application Priority Data
Feb. 15, 2008 (DE) 10 2008 009 422.6

(51) Int. Cl. A01L 15/00; A01L 11/00

(52) U.S. Cl. 168/48.1

(57) ABSTRACT

A hoof plane comprises cutting teeth with cutting edges which extend perpendicular to the longitudinal axis and therefore to the working direction. The cutting teeth and the chip breaker grooves are formed by machining and extend at an angle of 45° relative to the longitudinal axis. The hoof plane consists of a high-quality tool steel and has a hardness of at least 64 HRC.

### BACKGROUND OF THE INVENTION

1. Field of the Invention

The invention relates to a hoof plane, in particular for the hooves of horses.

2. Background Art

A hoof rasp is known from DE 201 17 786 U1 which comprises a rasp surface which is composed of individual pointed teeth which are arranged in rows that are arranged at an angle relative to the longitudinal axis of the rasp.

A hoof plane is known from WO 99/30558 A1 which comprises a file surface and a rasp surface, wherein the cutting edges of the rasp are arranged at an angle of approximately 45° relative to the longitudinal axis of the rasp.

A driven milling tool for hoof trimming is known from DE 76 03 705 U in which milling tool the cutting edges are recessed with respect to the groove base to achieve an undercut chip removal.

Files are known from DE 460 335 A and U.S. Pat. No. 1,433,306 A which are produced by milling and which are provided with undercut cutting edges.

Files are known from DE 547 096 A and GB 577 391 A which are provided with chip breaker grooves.

Horse hooves need to be trimmed at regular intervals which is done using a hoof knife or hoof cutting pliers. Afterwards, the hooves are treated with a hoof rasp which is usually provided with a rasp surface for rough treatment of the horn and a file surface for finer after-treatment such as smoothing the outer hoof wall. If the hooves are shoed with a horseshoe, the file surface of the rasp is used to treat the nails, the outer hoof and the iron.

The known hoof rasps may be provided with a tang in the shape of a handle or for joining a handle thereto. The rasp teeth on the rasp surface are chisel-cut, i.e. the rasp surface is produced by means of a so-called cutting chisel which is used to work the steel. The teeth are raised in a forming process, in other words they are driven up from the rasp surface. This results in an uneven tooth geometry. The rasp body must be made of a steel which has a comparatively low strength for the cutting chisel to penetrate deep enough into the rasp body. In other words, the steel may contain only a low amount of carbon and no chromium. Owing to these preconditions, the steel has a hardness of no more than 58 HRC after hardening. The described cutting process is dependent on the annealing state of the steel that is used, in other words on the soft annealing of the steel prior to cutting the teeth, and on the geometry and the wear of the cutting chisel. Moreover, the design and state of maintenance of the cutting machines is of vital importance. These numerous potential faults in the production of the hoof rasp lead to considerable quality variations as the cutting teeth are raised to very different extents. Furthermore, the force and effort required for rasping is quite extensive.

### SUMMARY OF THE INVENTION

Therefore, it is the object of the invention to create a tool for the treatment of hooves, in particular the hooves of horses, which produces an even cut at a high cutting performance whilst ensuring high stability and low effort.

This object is achieved according to the invention by a hoof plane comprising
a longitudinal plane body
   which comprises a plane surface and
   a length a, which is long in relation to the width b thereof, and a longitudinal axis, and
   which is hardened,
cutting teeth formed on the plane surface which
   extend parallel to each other and perpendicular to the longitudinal axis, and
   have a front surface, which is arranged upstream in a working direction and is formed as a face, and a flank, which is in each case arranged downstream of said face when seen in the working direction,
   wherein a cutting edge is formed in an intersection line of the face and the flank, wherein the face that is arranged upstream of a cutting edge in the working direction and the flank of the cutting tooth that is arranged upstream of and next to said face together define a chip space,
   wherein the cutting teeth are formed by machining, and
chip breaker grooves in the cutting teeth which
   form secondary blades on the cutting teeth,
   extend at an angle δ2 relative to the cutting edges, and
   are formed by machining.

Owing to the type of design and arrangement of the cutting teeth, the tool cannot be described as a file or a rasp but should rather be called a hoof plane. The blade geometry of the plane surface is such that the hoof plane does not tear out individual chips from the hoof but cuts them, which results in a better hoof surface quality than using a chisel-cut rasp. As both the cutting teeth and the chip breakers are formed by machining, usually milling, the straight teeth have a particularly even shape; they all have the same blade geometry, and therefore have a uniform effect. Having been cut from the hoof, the chips slide evenly off the cutting edge and across the cutting surface before reaching the chip space, which greatly reduces friction between the chips and the hoof plane. The inclined, free position of the flank relative to the treated surface of the hoof also minimizes friction. Both aspects result in a considerable reduction of effort required for planing. Furthermore, as the blades are formed by machining, a high-quality tool steel may be used which has a hardness of at least 64 HRC after hardening. This results in a high stability of the hoof plane.

Further features, advantages and details of the invention will become apparent from the ensuing description of an embodiment by means of the drawing.

### BRIEF DESCRIPTION OF THE DRAWING

FIG. 1 shows a plan view of a hoof plane according to the invention, wherein the cutting teeth and the chip breaker grooves are only partially shown;

FIG. 2 shows a longitudinal side view of the hoof plane according to FIG. 1;

FIG. 3 shows a partial side view according to section III in FIG. 2 which is greatly enlarged with respect to FIG. 2;

FIG. 4 shows a greatly enlarged partial cross-sectional view of the hoof plane along line IV-IV in FIG. 1; and

FIG. 5 shows a partial oblique view of the hoof plane which is greatly enlarged with respect to FIG. 1.

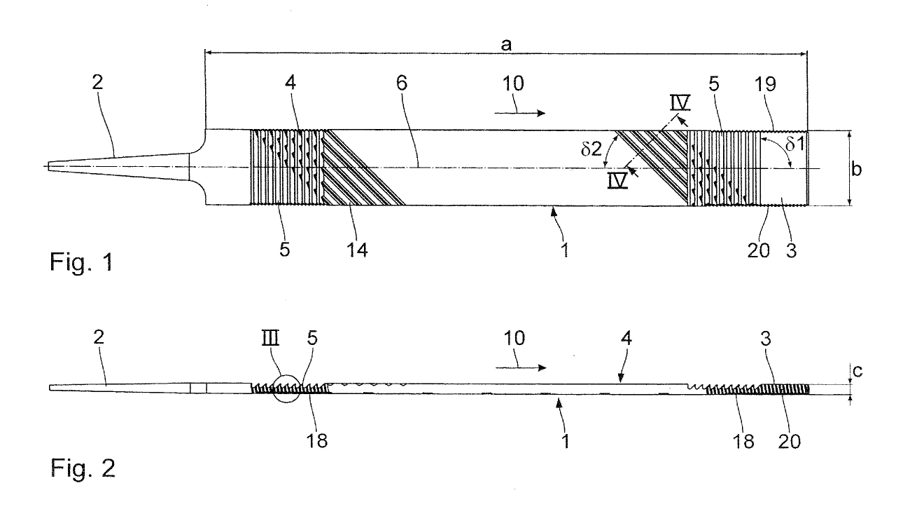

### DESCRIPTION OF THE PREFERRED EMBODIMENT

The hoof plane shown in the drawing comprises a longitudinal, generally cuboidal plane body 1, which is thus rectangular when seen from above, in the shape of a file body with a length a of 320 to 370 mm, a width b of 43 to 48 mm and a thickness c of 5 to 8 mm. On one end, the plane body 1 is provided with a so-called tang 2 as is commonly used in files. The user may attach a handle to a tang 2 of this type. On the end remote from the tang 2, the plane body 1 is provided with a so-called palm rest 3, i.e. a surface area which is not provided with teeth for the user to place his hand when using the plane.

The plane surface 4 shown in the drawing is provided with cutting teeth 5 which are arranged at an angle δ1 relative to the longitudinal axis 6 of the plane body 1 to which angle δ1 applies: δ1=90°. Minor deviations from δ1=90° are of course conceivable. Consequently, the cutting teeth 5 extend perpendicular to the longitudinal axis 6 of the plane and therefore also perpendicular to the direction of planing.

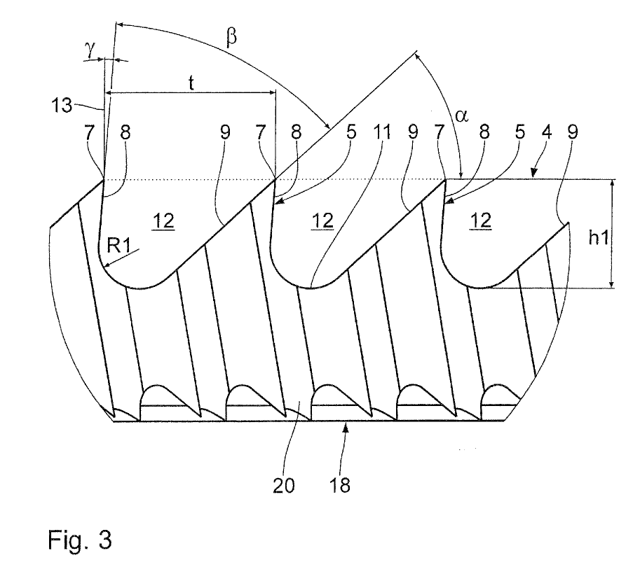

As can be seen from FIG. 3, the cutting teeth 5 have cutting edges 7 which extend perpendicular to the longitudinal axis 6 and are formed by the intersection of face 8 and flank 9. Seen in the working direction 10 of the plane, in other words in the direction of planing, the face 8 is arranged upstream of the cutting edge 7 while the flank 9 is arranged downstream thereto. The flank 9 of an upstream cutting tooth 5 and the face 8 of a tooth 5 which is arranged directly downstream of the upstream tooth 5 form a chip space 12 with a chip space bottom 11 that has a cross-section in the shape of a circular segment. The chip space bottom 11 has a cross-section with a radius R1. The flank 9 of each cutting tooth 5 and the plane surface 4 form a relief angle α, wherein to the relief angle applies: 30°≦α≦50°. The face 8 and a perpendicular 13 to the plane surface 4 form a positive rake angle γ to which applies: 0°<γ≦20°, “positive” meaning that the face 8 is inclined in the working direction 10 from the chip space bottom 11 towards the cutting edge 7. The flank 9 and the face 8 of one and the same chip space 12 form a wedge angle β to which applies: β90°−γ−α. The tooth pitch t, in other words the distance between two adjacent cutting edges 7 in the direction of the longitudinal axis 6, is such that 3 mm≦t≦7 mm. The tooth height h1 is constant across the width of each cutting tooth 5 and is in the range of 0.5 mm to 3.0 mm, wherein the precise height h1 thereof is obtained from the radius R1 of the chip space bottom 11, the pitch t, the rake angle γ and the relief angle α.

The cutting teeth 5 are provided with so-called chip breaker grooves 14 which extend at an angle δ2 with respect to the longitudinal axis 6 of the plane body 1, wherein the following applies: δ2=45°. The chip breaker grooves 14 in one and the same cutting tooth 5 are arranged at such a lateral distance from each other that a chip breaker groove 14 of a cutting tooth 5 is arranged centrally—relative to the longitudinal axis 6 of the plane body 1—between two adjacent chip breaker grooves 14 of the nearest upstream or the nearest downstream cutting tooth 5. Proceeding from the pitch t, a cutting element length d between two adjacent chip breaker grooves 14 of a cutting tooth 5 is obtained, wherein 3 mm≦d≦8 mm.

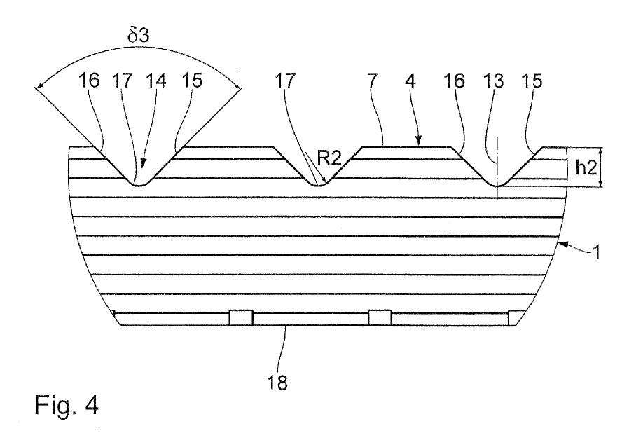

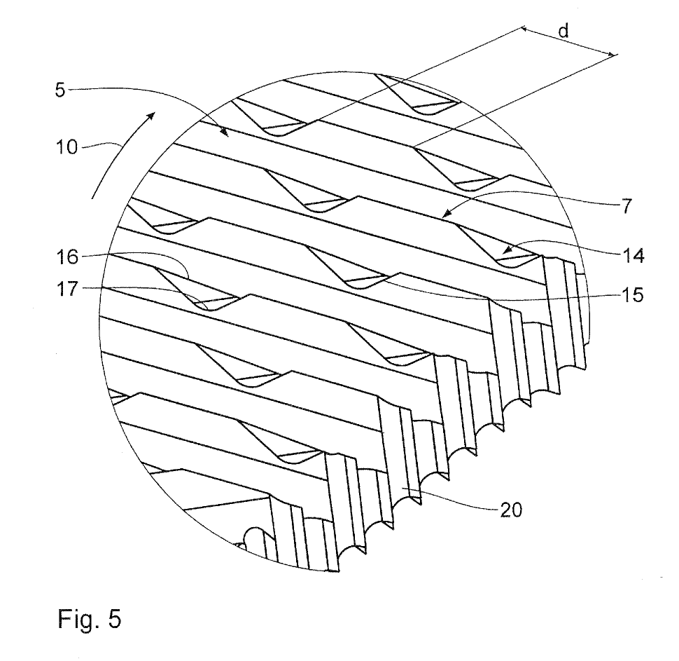

As can be seen from FIG. 4, the chip breaker grooves 14 are formed by so-called secondary blades 15, 16 which form an opening angle δ3. The secondary blades 15, 16 are interconnected by a foot portion 17 which has a cross-section in the shape of a circular segment and a radius R2 of approximately 0.5 mm. The secondary blades 15, 16 are arranged mirror-symmetrically with respect to the perpendicular 13 on the plane surface 4. The opening angle δ3 is such that 85°≦δ3≦95°. The depth h2 of the chip breaker grooves 14 is lower than the tooth height h1. Therefore, in relation to the plane surface 4, the foot portion 17 is on a higher level than the chip space bottom 11.

Both the cutting teeth 5 and the chip breaker grooves 14 are formed by machining, preferably milling, which results in a very precise shape of the cutting teeth 5 comprising the cutting edges 7 and of the chip breaker grooves 14 comprising the secondary blades 15, 16. The same applies to the faces 8 and the flanks 9.

The plane body 1 consists of a high-quality tool steel with a carbon content of 1.30 to 1.50% and a chromium content of 0.35 to 0.8%. After producing the cutting teeth 5 and the chip breaker grooves 14, the plane body 1 is hardened to have a hardness of at least 64 HRC. The chromium content and the carbon content promote the formation of carbides. Accordingly, the hoof plane has an extraordinarily high service life.

Along with the selection of material, the described geometry of the plane surface 4, in other words the described design of the cutting edges 7 and the chip breaker grooves 14 which are formed by machining, results in an optimal ratio of removal relative to the effort which is required therefor, and relative to the service life of the hoof plane.

The side of the plane body 1 opposite to the plane surface 4 may also be provided with teeth, for instance with file teeth 18. Likewise, the lateral edges may be provided with lateral teeth 19, 20 which are, owing to the described selection of material, also formed by machining. The file teeth 18 may in particular be designed in such a way as to be suitable for filing the nails used for shoeing horses to the desired length after shoeing.

What is claimed is:

1. A hoof plane comprising
a longitudinal plane body (1)
which comprises a plane surface (4) and
a length a, which is long in relation to a width b thereof, and a longitudinal axis (6), and
which is hardened,
cutting teeth (5) formed on the plane surface (4) which
extend parallel to each other and perpendicular to the longitudinal axis (6), and
have a front surface, which is arranged upstream in a working direction (10) and is formed as a face (8), and a flank (9), which is in each case arranged downstream of said face (8) when seen in the working direction (10),
wherein a cutting edge (7) is formed in an intersection line of the face (8) and the flank (9), wherein the face (8) that is arranged upstream of a cutting edge (7) in the working direction (10) and the flank (9) of the cutting tooth (5) that is arranged upstream of and next to said face (8) together define a chip space (12),
wherein the cutting teeth (5) are formed by machining, and
chip breaker grooves (14) in the cutting teeth (5) which
form secondary blades (15, 16) on the cutting teeth (5),
extend at an angle 62 relative to the cutting edges (7), and
are formed by machining.

2. A hoof plane according to claim 1, wherein
the cutting teeth (5) form an angle δ1 with the longitudinal axis (6) to which angle δ1 applies: δ1≃90°.

3. A hoof plane according to claim 1, wherein
the chip breaker grooves (14) form an angle δ2 with the longitudinal axis (6) to which angle δ2 applies: δ2≃45°.

4. A hoof plane according to claim 1, wherein
the face (8) forms a rake angle γ with a perpendicular (13) to the plane surface (4) to which rake angle γ applies: 0<γ≦20°.

5. A hoof plane according to claim 1, wherein
the flank (9) and the plane surface (4) form a relief angle α to which applies: 30°≦α≦50°.

6. A hoof plane according to claim 1, wherein
the chip breaker grooves (14) have an opening angle δ3 to which applies: 85≦δ3≦95°.

7. A hoof plane according to claim 1, wherein
the cutting teeth (5), which are adjacent in working direction (10), have a tooth pitch t, and wherein the tooth pitch t and the arrangement of the chip breaker grooves (14) are such that relative to the working direction (10), one chip breaker groove (14) is formed in a cutting tooth (5) centrally opposite two adjacent chip breaker grooves (14) in the nearest upstream and in the nearest downstream cutting tooth (5).

8. A hoof plane according to claim 1, wherein
cutting teeth (5), which are adjacent in working direction (10), have a tooth pitch t to which applies: 3 mm≦t≦8 mm.

9. A hoof plane according to claim 1, wherein
to the tooth height h1 of the cutting teeth (5) in relation to the depth h2 of the chip breaker grooves (14) applies: h1>h2.

10. A hoof plane according to claim 1, wherein
the plane body (1) has a hardness of at least 64 HRC.
